(19) United States
(12) Patent Application Publication
(10) Pub. No.: US 2025/0023389 A1
(43) Pub. Date: Jan. 16, 2025

(54) LOGISTICS HANDLING SYSTEM AND METHOD

(71) Applicant: SEMES CO., LTD., Cheonan-si (KR)

(72) Inventors: Ki Sub YOON, Gyeonggi-do (KR); Sang Soo JEONG, Daegu (KR)

(73) Assignee: SEMES CO., LTD., Cheonan-si (KR)

(21) Appl. No.: 18/630,158

(22) Filed: Apr. 9, 2024

(30) Foreign Application Priority Data
Jul. 12, 2023 (KR) 10-2023-0090444

(51) Int. Cl. H02J 50/10; B61B 13/00; H02J 9/06

(52) U.S. Cl. CPC H02J 50/10; B61B 13/00; H02J 9/068

(57) ABSTRACT

A logistics handling system and method are provided. A logistics handling system includes: a traveling rail provided on a set section; a traveling unit traveling on the traveling rail; and a power supply device supplying external power to a demander in a non-contact manner, wherein a plurality of traveling units having different operation manners are operated on the traveling rail, and any one of the plurality of traveling units is operated depending on state conditions of the power supply device.

### CROSS-REFERENCE TO RELATED APPLICATION

This application claims priority from Korean Patent Application No. 10-2023-0090444 filed on Jul. 12, 2023, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a logistics handling system and method.

### 2. Description of the Related Art

In the logistics handling system, a power supply device and an OHT unit operate in conjunction with each other. To handle parts for the power supply device (e.g., maintenance, repair, replacement management, etc.), the power supply device requires backup to enable alternative operation through interconnection with other power supply devices. However, when parts related to such backup among the association parts of the power supply are subject to handling, an operation of a traveling means on a rail linked to the parts being handled is inevitably limited. This will soon lead to a decrease in logistics throughput.

### RELATED ART DOCUMENT

### Patent Document

(Patent Document 1) Korean Patent Laid-Open Publication No. 10-2023-0016798

### SUMMARY

Aspects of the present disclosure are to continuously enable stable logistics handling in response to power supply conditions.

Aspects of the present disclosure are also to ensure that an interconnected operation of a power supply device and an OHT unit on a system is operated while being stably maintained.

Aspects of the present disclosure are also to enable an operation of an OHT unit that prevents a decrease in logistics throughput in response to periodic and unexpected handling and management of a power supply device on a system.

Aspects of the present disclosure are also to enable that an OHT unit may stably and efficiently operate without being restricted by these situations even in situations where a specific part for backup between power supply devices is handled (e.g., maintenance, repair, replacement management, etc.).

Aspects of the present disclosure are not limited to the above-mentioned aspects. That is, other aspects that are not mentioned may be obviously understood by those skilled in the art from the following specification.

According to an aspect of the present disclosure, there is provided a logistics handling system including: a traveling rail provided on a set section; a traveling unit traveling on the traveling rail; and a power supply device supplying external power to a demander in a non-contact manner, wherein a plurality of traveling units having different operation manners are operated on the traveling rail, and any one of the plurality of traveling units is operated depending on state conditions of the power supply device.

According to another aspect of the present disclosure, there is provided a logistics handling method including: operating a logistics handling system; performing part handling related to power supply of the logistics handling system; and performing logistics handling even in the part handling state of the logistics handling system, wherein the logistics handling system includes: a traveling unit traveling on a traveling rail, and a power supply device supplying external power to a demander in a non-contact manner, a plurality of traveling units having different operation manners are operated on the traveling rail, and any one of the plurality of traveling units is operated depending on state conditions of the power supply device.

According to the logistics handling system and method of the present disclosure as described above, there are one or more of the following effects.

First, the stable logistics handling is continuously possible in response to the power supply status on the system.

Second, it ensures that the interconnected operation of the power supply device and the OHT unit on the system is operated while being stably maintained.

Third, it is possible to operate the OHT unit that prevents the decrease in logistics throughput in response to the periodic and unexpected handling and management of the power supply device on the system.

Fourth, the OHT unit may stably and efficiently operate without being restricted by these situations even in the situations where the specific part for backup between the power supply devices is handled (e.g., maintenance, repair, replacement management, etc.).

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating a configuration of a logistics handling system according to an exemplary embodiment of the present disclosure;

FIG. 2 is a block diagram illustrating the configuration according to FIG. 1 in detail;

FIG. 3 is a diagram illustrating some of the configurations according to FIG. 2;

FIGS. 4 and 5 are block diagrams illustrating the configurations according to an operation of a power supply device according to FIG. 2;

FIG. 6 is a block diagram illustrating the configurations according to another operation of the power supply device according to FIG. 2; and

FIG. 7 is a flowchart sequentially illustrating a logistics handling method according to an exemplary embodiment of the present disclosure.

### DETAILED DESCRIPTION OF THE EMBODIMENTS

Hereinafter, exemplary embodiments of the present disclosure will be described in detail with reference to the accompanying drawings. Advantages and features of the present disclosure, and a method for achieving the advantages and features will become apparent with reference to the exemplary embodiments described below in detail in conjunction with the accompanying drawings. However, the present disclosure is not limited to the exemplary embodiments disclosed below, but may be implemented in a variety of different forms, these exemplary embodiments will be provided only in order to make the present disclosure complete and allow those skilled in the art to completely recognize the scope of the present disclosure, and the present disclosure is only defined by the scope of the claims. The same reference numbers indicate the same components throughout the specification.

Spatially relative terms “below”, “beneath”, “lower”, “above”, “upper”, and the like,

may be used to easily describe correlations between one target or components and another target or components as illustrated in the drawings. The spatially relative terms are to be understood as terms including different directions of the targets at the time of use or at the time of operation in addition to the directions illustrated in the drawings. For example, when a target illustrated in the drawing is turned over, a target described as being ‘below or beneath’ another target may be located ‘above’ another target. Therefore, an exemplary term ‘below’ may include both of directions of below and above. The target may also be oriented in other orientations, and thus spatially relative terms may be interpreted according to the orientation.

The terms “first”, “second” and the like are used to describe various targets, components, and/or sections but these targets, components, and/or sections are not limited by these terms. These terms are used only in order to distinguish one target, component, or section from another target, component, or section. Accordingly, a first target, a first component, or a first section mentioned below may also be a second target, a second component, or a second section within the spirit of the present disclosure.

The terms used herein are for the purpose of describing the exemplary embodiments and are not intended to limit the present disclosure. In the present specification, a singular form includes a plural form unless explicitly stated otherwise. Components, steps, operations, and/or targets mentioned by terms “comprise” and/or “comprising” used in the present disclosure do not exclude the existence or addition of one or more other components, steps, operations, and/or targets. Unless defined otherwise, all terms (including technical and scientific terms) used in the present specification have the same meaning as meanings commonly understood by those skilled in the art to which the present disclosure pertains. In addition, terms defined in generally used dictionaries are not ideally or excessively interpreted unless specifically defined clearly.

Hereinafter, exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

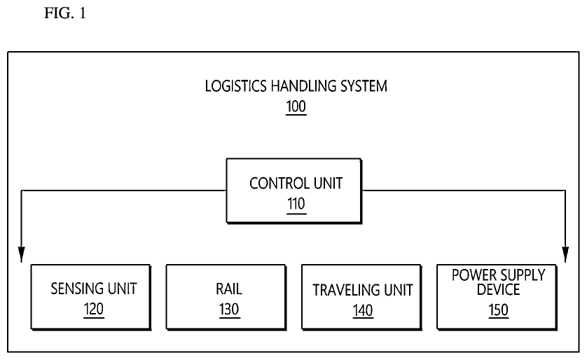

FIG. 1 is a block diagram illustrating a configuration of a logistics handling system 100 (hereinafter, referred to as “system 100”) according to an exemplary embodiment of the present disclosure. Referring to FIG. 1, the system 100 according to an exemplary embodiment of the present disclosure includes a control unit 110, a sensing unit 120, a rail 130, a traveling unit 140, and a power supply device 150.

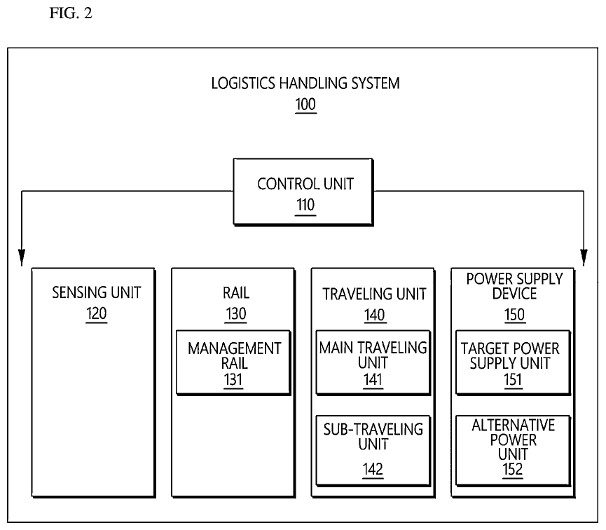

FIG. 2 is a block diagram illustrating the configuration according to FIG. 1 in detail. Referring to FIG. 2, the rail 130 includes a management rail 131. Here, the traveling unit 140 includes a main traveling unit 141 and a sub-traveling unit 142. The power supply device 150 includes a target power supply unit 151 and an alternative power supply unit 152.

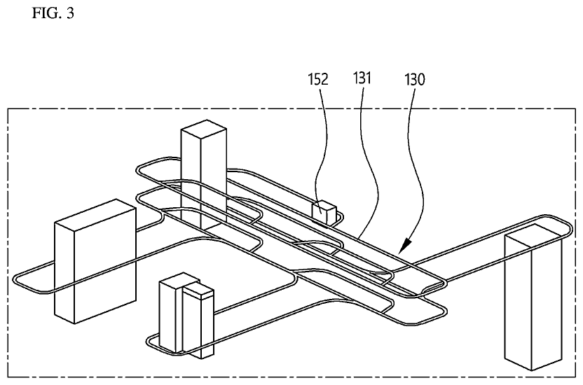

FIG. 2 is a block diagram illustrating the configuration according to FIG. 1 in detail. FIG. 3 is a diagram illustrating some of the configurations according to FIG. 2. Referring to FIGS. 2 and 3, the traveling rail 130 of the system 100 is provided on a set section of a line for logistics handling.

Here, the traveling unit 140 of the system 100 travels on the traveling rail 130 for logistics handling. The power supply device 150 of the system 100 supplies external power to a demander in a non-contact manner.

The power supply device 150 supplies external power to the traveling unit 140 through the rail 130. The power supply device 150 is not limited thereto, and may also directly supply external power to the traveling unit 140. A plurality of traveling units 140 having different operation manners may be operated on the traveling rail 130.

Any one of the plurality of traveling units 140 is operated according to state conditions of the power supply device 150. The main traveling unit 141 of the traveling unit 140 travels on the traveling rail 130 based on the external power.

The sub-traveling unit 142 of the traveling unit 140 travels on the traveling rail 130 based on internal power. The sub-traveling unit 142 may replace the main traveling unit 141 and operate independently on the traveling rail 130 according to the state conditions of the power supply device 150.

In addition, the sensing unit 120 of the system 100 senses the presence or absence of a traveling object on the traveling rail 130 and generates sensing information. The power supply device 150 is provided in plural.

The target power supply unit 151 corresponds to a target on which handling (e.g., maintenance, replacement, etc.) of an association part 10 for performing a backup operation (e.g., an operation in which another device replaces and performs a power supply role performed by one device, etc.) between the target power supply units 151 of the power supply device 150 is performed.

Meanwhile, the corresponding rail 130 of the traveling rail 130 corresponds to the rail 130 corresponding to the target power supply unit. In the traveling unit 140, the sub-traveling unit 142 excluding the main traveling unit 141 may be traveled on the corresponding rail 130 based on the sensing information.

When the main traveling unit 141 does not exist on the management rail 131 based on the sensing information, the part handling is performed for the target power supply unit 151. If the part handling for the target power supply unit 151 is completed, the traveling unit 140 may be operated on the management rail 131.

The alternative power supply unit 152 of the power supply device 150 may operate separately from the target power supply unit 151. The target power supply unit 151 and the alternative power supply unit 152 each include an association part 10 involved in performing a mutual replacement operation.

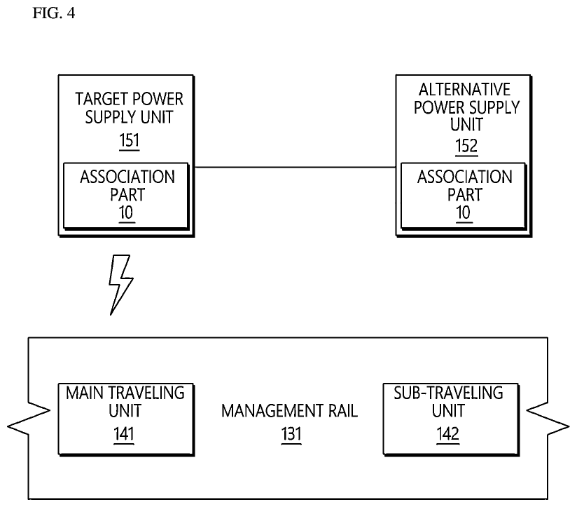

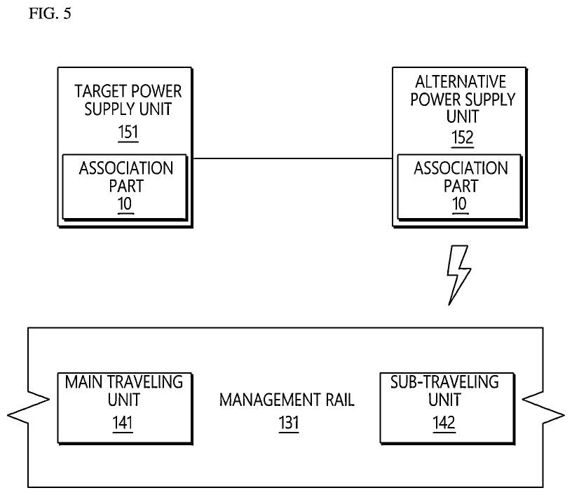

FIGS. 4 and 5 are block diagrams illustrating the configurations according to an operation of a power supply device 150 according to FIG. 2. Referring to FIGS. 4 and 5, the target power supply unit 151 may supply power, or the alternative power supply unit 152 may supply power by replacing the target power supply unit 151.

In this case, when the operation of the association part 10 is restricted due to the handling of the association part 10, it is general that an operation of a traveling means is also restricted. Therefore, logistics throughput is reduced.

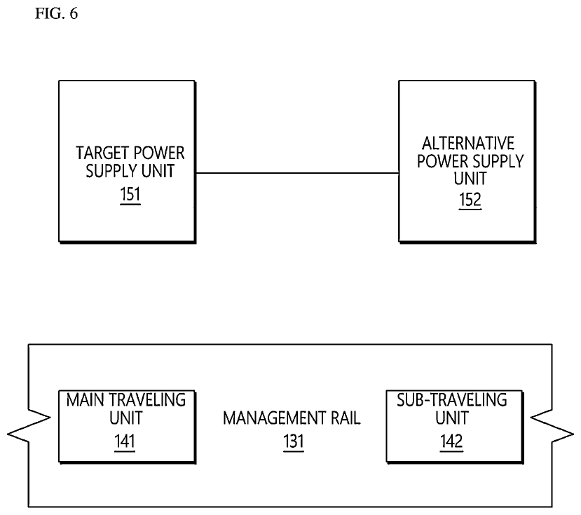

FIG. 6 is a block diagram illustrating the configurations according to another operation of the power supply device 150 according to FIG. 2. Referring to FIG. 6, according to the present disclosure, the sub-traveling unit 142 may be operated on the corresponding rail 130 despite the handling of the association part 10.

According to the present disclosure, even in situations where the power supply device 150 is handled as illustrated in FIGS. 4 and 5, the reduction in logistics throughput may be prevented based on mutual operation of the main traveling unit 141 and the sub-traveling unit 142.

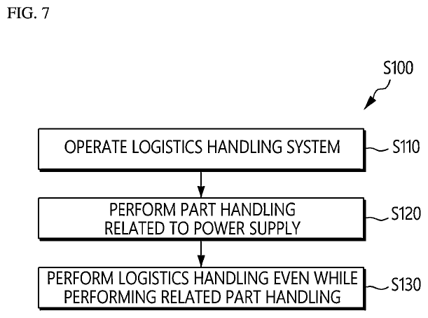

FIG. 7 is a flowchart sequentially illustrating a logistics handling method (S100) according to an exemplary embodiment of the present disclosure. Referring to FIG. 7, in the logistics handling method (S100), the logistics handling system 100 is operated in S110.

In S120, part handling related to power supply of the logistics handling system 100 is performed. In S130, logistics handling is performed even in the part handling state of the logistics handling system 100.

Here, in the logistics handling system 100, the traveling unit 140 travels on the traveling rail 130, and the power supply device 150 supplies external power in a non-contact manner for such traveling. A plurality of traveling units 140 having different operation manners may be operated on the traveling rail 130.

For example, any one of the plurality of traveling units 140 is operated depending on state conditions of the power supply device 150. The main traveling unit 141 of the traveling unit 140 travels on the traveling rail 130 based on the external power. The sub-traveling unit 142 of the traveling unit 140 travels on the traveling rail 130 based on internal power.

Although the embodiments of the present disclosure have been described with reference to the accompanying drawings, those of ordinary skill in the art to which the present disclosure pertains will understand that the present disclosure may be embodied in other specific forms without changing the technical spirit or essential features thereof. Therefore, it is to be understood that the exemplary embodiments described above are illustrative rather than being restrictive in all aspects.

What is claimed is:

1. A logistics handling system comprising:
a traveling rail provided on a set section;
a traveling unit traveling on the traveling rail; and
a power supply device supplying external power to a demander in a non-contact manner,
wherein a plurality of traveling units having different operation manners are operated on the traveling rail, and
any one of the plurality of traveling units is operated depending on state conditions of the power supply device.

2. The logistics handling system of claim 1, wherein the traveling unit includes:
a main traveling unit traveling on the traveling rail based on the external power supply, and
a sub-traveling unit traveling on the traveling rail based on internal power.

3. The logistics handling system of claim 2, wherein the sub-traveling unit replaces the main traveling unit and operates independently on the traveling rail according to the state conditions of the power supply device.

4. The logistics handling system of claim 3, further comprising a sensing unit sensing the presence or absence of a traveling object on the traveling rail and generating sensing information,
wherein the power supply device includes a target power supply unit on which part handling is performed, and
the traveling rail includes a corresponding rail corresponding to the target power supply unit.

5. The logistics handling system of claim 4, wherein in the traveling unit, the sub-traveling unit excluding the main traveling unit is traveled on the corresponding rail based on the sensing information.

6. The logistics handling system of claim 5, wherein when the main traveling unit does not exist on the management rail based on the sensing information, the part handling is performed for the target power supply unit.

7. The logistics handling system of claim 5, wherein the power supply device further includes an alternative power supply unit that operates separately from the target power supply unit,
the target power supply unit and the alternative power supply unit each include an association part involved in performing a mutual replacement operation, and
the sub-traveling unit is operated on the corresponding rail even when an operation of the target power supply unit is restricted due to the handling of the association part in the part handling.

8. A logistics handling method comprising:
operating a logistics handling system;
performing part handling related to power supply of the logistics handling system; and
performing logistics handling even in the part handling state of the logistics handling system,
wherein the logistics handling system includes:
a traveling unit traveling on a traveling rail, and
a power supply device supplying external power to a demander in a non-contact manner,
a plurality of traveling units having different operation manners are operated on the traveling rail, and
any one of the plurality of traveling units is operated depending on state conditions of the power supply device.

9. The logistics handling method of claim 8, wherein the traveling unit includes:
a main traveling unit traveling on the traveling rail based on the external power supply, and
a sub-traveling unit traveling on the traveling rail based on internal power.

10. The logistics handling method of claim 9, wherein the sub-traveling unit replaces the main traveling unit and operates independently on the traveling rail according to the state conditions of the power supply device.
